(19) United States
(12) Patent Application Publication
(10) Pub. No.: US 2022/0224411 A1
(43) Pub. Date: Jul. 14, 2022

(54) METHOD FOR DECODING A LUMINOUS COMMUNICATION SIGNAL AND OPTOELECTRONIC SYSTEM

(71) Applicant: ELLIPZ SMART SOLUTIONS EUROPE, Paris (FR)

(72) Inventors: Suat TOPSU, VERSAILLES (FR); Perez Olivas Huetzin AARON, Covina, CA (US); Green Ojeda Jacob EMIR, San José Del Cabo, Baja California Sur (MX); Jean-Baptiste SEILLIERE, CHAMBESY (CH); Johannes Otto ROOYMANS, OSS (NL)

(21) Appl. No.: 17/609,121

(22) PCT Filed: May 5, 2020
(86) PCT No.: PCT/FR2020/000160

§ 371 Date: Nov. 5, 2021

(30) Foreign Application Priority Data
May 5, 2019 (FR) 1904699

(51) Int. Cl. H04B 10/116; H04B 10/69; H04B 10/556

(52) U.S. Cl. CPC H04B 10/116; H04B 10/5563; H04B 10/691

(57) ABSTRACT

The invention relates to a method for decoding (10) a modulated light signal (35) carrying a digital data set, the decoding method (10) comprising a step of searching (12, 13, 14, 15) for at least two frequencies of oscillation of a digital transcription of the light signal detected by a photodetector (23), each frequency of oscillation being representative of a logic value of the bits constituting the digital data carried by the light signal. Advantageously, a most significant bit is represented by a first frequency of oscillation and a least significant bit is represented by a second frequency of oscillation, the first frequency of oscillation being chosen so as to form, at the photodetector (23), a digital signal that is larger than that formed by the second frequency of oscillation by at least 4 elementary detection units of said photodetector (23).

The invention also relates to an optoelectronic system (20) that implements a decoding method (10) of this kind.

### TECHNICAL FIELD

The technical context of the present invention is that of communication by way of light in order to transport digital data by means of a modulated light beam. More specifically, the invention relates to a method for decoding a modulated light signal carrying a digital data set. The invention also relates to an optoelectronic system that makes it possible to implement a decoding method of this kind.

### PRIOR ART

In the prior art, light communication systems are known, such as those which implement LiFi (“Light Fidelity”) technology, which allows digital data to be transmitted wirelessly by modulating the light emitted by LED (Light Emitting Diode) lights. LiFi technology is described in particular in the international standard IEEE802.15.

A known use of this technology is linked to the development of indoor geolocation services in order to be able to locate a LiFi receiver in a network of LiFi transmitters formed by the same number of LED lighting devices. In such a use, each LED lighting device is configured to emit a sequence of light signals which carry predetermined geolocation information. In other words, the sequence of light signals corresponds to an optical transposition of a digital signal that groups together binary data. As is known, a LiFi reception module is configured to receive the sequence of light signals and to deduce therefrom the geolocation information emitted by the LED lighting device.

The use of a LiFi geolocation system of this kind is known in museums, hospitals or supermarkets in order to send geolocation information to a specific portable terminal and to facilitate interactions between users and the place in which the geolocation system is deployed. By way of non-limiting example, the specific terminal can take the form of an audio guide or a tablet specifically developed for this use because it must include a LiFi reception module that makes it possible to detect the light signal in order to be able to decode the geolocation information transported by said light signal.

Light communication systems of this kind are costly to develop and integrate because it is necessary both to deploy a network of lighting devices and to make a specific terminal available to its users.

It is also known to use mobile phones to detect a modulated light signal carrying encoded information, in particular by means of a camera of the mobile phone. However, due to the bandwidth of such a camera, only low data rates make its use compatible with communication by light. In addition, the prototypes currently developed are still unreliable and do not make it possible to receive a constant flow of data without losses.

In particular, document WO2018130559A1 is known, which describes a decoder intended to decode a visible-light-modulated signal by (i) receiving a series of frames captured by a camera, (ii) sampling a plurality of parts of each frame in order to obtain a time series of samples, (iii) determining a value of a property which smooths out temporal variations for each part of the frame, (iv) using the property value to correct a non-uniformity in the light source, and (v) applying the correction to each of the parts in order to detect the encoded light signal based thereon.

Document WO2018015187A1 is also known, which describes a camera that captures at least one image of luminous zones that transmit data. The system is further designed to (i) spatially modulate at least part of the emitted light using a spatial pattern, and (ii) distinguish each lighting unit that transmits data based on an autocorrelation of the spatial pattern.

Finally, the document WO2016001339A1 is known, which describes a light-emitting device used to emit light intended to be detected by a rolling shutter camera, the rolling shutter camera having an image capture element that is divided into a plurality of lines which are exposed in a sequence.

An aim of the invention is to propose a new method for decoding a modulated light signal in order to address the above-described problems at least to a large extent and also to produce other advantages.

Another aim of the invention is to better detect the modulation of light intensity of the detected light signal in order to improve its reliability and to reduce the number of bits lost during such communication by light.

Another aim of the invention is to make it possible to use a camera of a mobile phone to decode an optical light signal that carries information.

### DISCLOSURE OF THE INVENTION

According to a first aspect of the invention, at least one of the aforementioned objectives is achieved by means of a method for decoding a modulated light signal carrying a digital data set, said method comprising at least one iteration of the following steps: (i) a step of acquiring the modulated light signal modulated with an areal photodetector, (ii) a step of converting the light signal detected by the areal photodetector into a two-dimensional representation representing a variation in light intensity of said light signal detected on the surface of said areal photodetector, the step of converting being carried out by an analog-digital converter, (iii) a step of computing a trend function using all or some of the two-dimensional representation, the step of computing being carried out by a computing unit, (iv) a step of subtracting the trend function from at least part of the two-dimensional representation in order to obtain a processed signal from the light signal detected by the areal photodetector, the step of subtracting being carried out by the computing unit, (v) a step of scanning the processed signal in order to detect all the occurrences of at least two frequencies of oscillation, the step of scanning being carried out by the computing unit, (vi) a step of attributing a logic value to each occurrence of the at least two frequencies of oscillation, each separate frequency of oscillation being associated with one separate logic value, the step of attributing being carried out by the computing unit, (vii) a step of reconstructing the digital data set from the attributed logic values, the step of reconstructing being carried out by the computing unit.

In the decoding method according to the first aspect of the invention, the digital data have been transcribed, at an emitting system, into a frequency of oscillation specific to the variation in light intensity of the light signal: a first logic value of the digital data, for example equal to 1, is associated with the first frequency of oscillation of the light intensity of the light signal, and a second logic value of the digital data, for example equal to 0, is associated with the second frequency of oscillation of the light intensity of the light signal. Thus, the light signal emitted by the emitting system has a light intensity which varies between at least two binary states: a first state in which the light intensity of the light signal is not zero, and a second state in which the light intensity is zero. It is the temporal variation of the light intensity of the light signal between its two states which makes it possible to transcribe the logic values of the digital data transported. Rather than associating a logic value of the digital data is with a state of the light signal, each first logic value is associated with a first frequency of oscillation between the two states of the light signal, and each second logic value is associated with a second frequency of oscillation between the two states of the light signal.

The processed signal, resulting from the detection of the light signal by the areal photodetector, accounts for the variations in light intensity of the light signal: it therefore accounts for the different frequencies of oscillation that were used to encode the digital data. The object of the decoding method according to the first aspect of the invention specifically consists in proposing a new protocol for analyzing the light signal in order to easily find these different frequencies of oscillation and, ultimately, to trace the logic values of the different bits constituting the digital data carried by the light signal.

The decoding method according to the first aspect of the invention advantageously makes it possible to optimize the transmission of digital data by means of light and to make it compatible with the use of a camera of a mobile phone, for example. Indeed, the decoding method according to the first aspect of the invention makes it possible to better detect the variations in frequencies of a light signal and therefore to better decode the logic values of the digital data transported by the light signal.

The decoding method according to the first aspect of the invention advantageously comprises at least one of the improvements below, it being possible to take the technical features constituting said improvements alone or in combination:
The step of acquiring the modulated light signal is preferably carried out by means of sequential acquisition of the different parts of the photodetector. In particular, the step of acquiring comprises, in particular, a step of moving a shutter moving on the photodetector in order to “read” the intensity values detected on the surface thereof, each row of the photodetector being read successively by the moving shutter: a first row of the photodetector being read by the photodetector, then a second row adjacent to the first row is read by the photodetector, and so on up to a longitudinal end of the photodetector. This sequential reading of the photodetector advantageously makes it possible to carry out a two-dimensional spatial transcription of a temporal variation in the light intensity of the modulated light signal: it is therefore particularly suitable for the detection of a light communication signal;
The step of computing the trend function comprises a method chosen from a Baxter-King filter, a Christiano & Fitzgerald filter, a Hodrick-Pescott filter or a polynomial filter. These different filters thus make it possible to determine a trend for all or part of the two-dimensional representation of the detected light signal;
The step of converting comprises a two-dimensional representation step during which light intensity values detected by the photodetector are stored in a two-dimensional array stored on a storage unit and/or light intensity values detected by the photodetector are represented in a two-dimensional image displayed on a display device;
Before the step of computing the trend function, said decoding method comprises a step of selecting a subset of the two-dimensional representation, the step of computing the trend function being subsequently applied to the selected subset. This advantageous embodiment makes it possible to compute one of the preceding filters based on a sample that is representative of the light signal detected by the photodetector and/or so as not to take into account one or more artefacts caused by faults that occur during acquisition of said light signal;
According to a first alternative embodiment, the selected subset comprises at least part of a row or column of the two-dimensional representation. Advantageously, the selected subset is formed by one or more rows and/or one or more columns, optionally selected according to criteria such as their level of intensity and/or the absence of artefacts. This advantageous embodiment makes it possible to subsequently compute one of the preceding filters based on a sample that is representative of the light signal detected by the photodetector;
The step of selecting the subset comprises (i) calculating a mean value for each row of the two-dimensional representation; or (ii) calculating a mean value for each column of the two-dimensional representation. In other words, the step of selecting the subset comprises calculating, for each row of the two-dimensional representation, the mean of the values of all or some of the columns of said two-dimensional representation; alternatively, the step of selecting the subset comprises calculating, for each column of the two-dimensional representation, the mean of the values of all or some of the rows of said two-dimensional representation. This advantageous embodiment makes it possible to improve a signal-to-noise ratio of the two-dimensional representation of the light signal detected by the photodetector and, ultimately, to allow better computation of the trend function associated with said two-dimensional representation;
During the step of subtracting, the trend function is advantageously subtracted from the previously selected subset in order to determine the processed signal. In particular, according to a preferred embodiment of the invention according to the first aspect thereof, the step of subtracting comprises subtracting the trend function from the mean value of each row or each column of the two-dimensional representation;
The step of scanning the processed signal consists in detecting a first frequency of oscillation of said processed signal and a second frequency of oscillation of said processed signal. By way of non-limiting example, such detection of the first and second frequencies of oscillation is carried out using a Fourier transform function, or by a fast Fourier transform function, or even using narrow-band filtering or using an autocorrelation function;
The first frequency of oscillation is distant from the second frequency of oscillation by several Hertz. In other words, the first frequency of oscillation is different from the second frequency of oscillation, and the first frequency of oscillation is higher than the second frequency of oscillation by at least 5% of a bandwidth of the moving shutter of the photodetector, and preferably equal to 10% of the bandwidth of said moving shutter; or the first frequency of oscillation is different from the second frequency of oscillation, and the first frequency of oscillation is lower than the second frequency of oscillation by at least 5% of a bandwidth of the moving shutter of the photodetector, and preferably equal to 10% of the bandwidth of said moving shutter. Preferably, the first frequency of oscillation is at least two times higher than the second frequency of oscillation. This advantageous embodiment makes it possible to detect the two frequencies of oscillation separately and to reduce the risk of confusion between a first part of the processed signal, which should be associated with the first frequency of oscillation, and a second part of the processed signal, which should be associated with the second frequency of oscillation. In other words, this advantageous embodiment makes it possible to improve the reliability of the decoding method according to the first aspect of the invention;

The first frequency of oscillation is different from the second frequency of oscillation, such that the first frequency of oscillation produces, on the two-dimensional representation, a first period which comprises at least 4 rows or 4 columns more than a second period produced by the second frequency of oscillation on said two-dimensional representation. This advantageous embodiment makes it possible to ensure a clear distinction between each frequency of oscillation on the two-dimensional representation and, ultimately, to properly decode the digital signal carried by the light signal.

According to a second aspect of the invention, an optoelectronic system is proposed for detecting a light communication signal, the optoelectronic system comprising means that are configured to implement the decoding method according to the first aspect of the invention or according to any of the improvements thereto.

An optoelectronic system of this kind thus makes it possible to decode a light communication signal carrying digital data using a photodetector, in which light communication signal the digital data are represented by a first frequency of oscillation of the light signal for a first logic value of said digital data and by a second frequency of oscillation of the light signal for a second logic value of said digital data. This frequency coding of the digital data makes it possible to improve the reliability of the method of communication by means of light and to make said method compatible with a wide variety of photoreceptors, including generic photoreceptors which are usually found in cameras of mainstream electronic devices, such as mobile phones, computers or digital tablets.

In particular, the optoelectronic system according to the second aspect of the invention comprises (i) a photodetector that is configured to be able to detect a light communication signal, (ii) an analog-digital converter that is configured to convert the light communication signal detected by the photodetector into a digital signal that is representative of the different levels of intensity of said light communication signal, (iii) a computing unit that is configured to perform digital calculations and/or digital processing and/or logic operations on the digital signal, (iv) a storage unit that is configured to store digital data, and/or (v) a display unit that is configured to display digital data.

In a non-limiting manner, the photodetector of the optoelectronic system according to the second aspect of the invention is advantageously the camera of a mobile phone or of a digital tablet or of a laptop. By way of non-limiting example, the photodetector can take the form of a CMOS (Complementary Metal Oxide Semiconductor) sensor or of a CCD (Charged Coupled Device) camera.

More generally, the optoelectronic system according to the second aspect of the invention is integrated into a mobile phone or a laptop or a digital tablet, thus allowing its user to receive a light communication signal that transports digital data, for example a geolocation identifier.

By way of non-limiting examples, the processing unit advantageously comprises a microprocessor and/or a microcontroller, the storage unit comprises at least one memory of the like used in the field of computing, and the display unit comprises at least one digital display.

According to a third aspect of the invention, a light communication system is proposed, comprising (i) an emitting system that comprises at least one light source that is configured to emit a light signal of which an intensity and/or a frequency is modulated according to an encoded digital signal, and (ii) an optoelectronic system according to the second aspect of the invention or according to any of the improvements thereto. Therefore, according to the third aspect of the invention, the light communication system comprises both a device, i.e. the emitting system, which is configured to emit a light communication signal carrying previously encoded digital data and a device, i.e. the optoelectronic system, which is configured to decode the digital data transported by the light communication signal.

As explained previously, the emitting system generates a light communication signal carrying previously encoded digital data in such a way that a first logic value of said digital data is represented by a first frequency of oscillation of the light intensity of said light communication signal, and a second logic value of said digital data is represented by a second frequency of oscillation of the light intensity of said light communication signal. As mentioned above, the second frequency of oscillation is advantageously different from the first frequency of oscillation in order to ensure reliability and/or robustness of the light communication system. In other words, the first frequency of oscillation is higher than the second frequency of oscillation by several Hertz or, alternatively, the first frequency of oscillation is lower than the second frequency of oscillation by several Hertz. Advantageously, the first frequency of oscillation is chosen such that it produces, at the photoreceptor, a periodic signal that is at least 4 rows or 4 columns or 4 pixels larger than the signal produced by the second frequency of oscillation d.

Various embodiments of the invention are provided, incorporating, in all of their possible combinations, the various optional features set out herein.

### DESCRIPTION OF THE FIGURES

Other features and advantages of the invention will become apparent from the following description and from various embodiments given by way of illustration and non-limiting example with reference to the appended schematic drawings, in which:

FIG. 1 is a schematic view of the decoding method according to the first aspect of the invention;

FIG. 2 illustrates a step of the decoding method according to the first aspect of the invention and in which an example of a two-dimensional representation of the light signal detected by the photodetector is shown;

FIG. 3 illustrates a step of the decoding method according to the first aspect of the invention and in which an example of a subset used to compute a trend function of the two-dimensional representation of the light signal detected by the photodetector is shown;

FIG. 4 illustrates a step of the decoding method according to the first aspect of the invention and in which an example for computing the trend function of the two-dimensional representation of the light signal detected by the photodetector is shown;

FIG. 5 illustrates a step of the decoding method according to the first aspect of the invention and in which an example for reconstructing digital data from the light signal detected by the photodetector is shown;

FIG. 6 is a schematic representation of the optoelectronic system according to the second aspect of the invention;

FIG. 7 is a schematic representation of the light communication system according to the third aspect of the invention.

Of course, the features, variants and different embodiments of the invention can be associated with one another, in various combinations, insofar as they are not incompatible or mutually exclusive. It is in particular possible to envisage variants of the invention comprising only a selection of features described below in isolation from the other features described if this selection of features is sufficient to confer a technical advantage or to differentiate the invention from the prior art.

In particular, all the variants and all the embodiments described can be combined with one another if there is nothing to prevent this combination from a technical point of view.

In the figures, the elements common to multiple figures have the same reference sign.

### DETAILED DESCRIPTION OF THE INVENTION

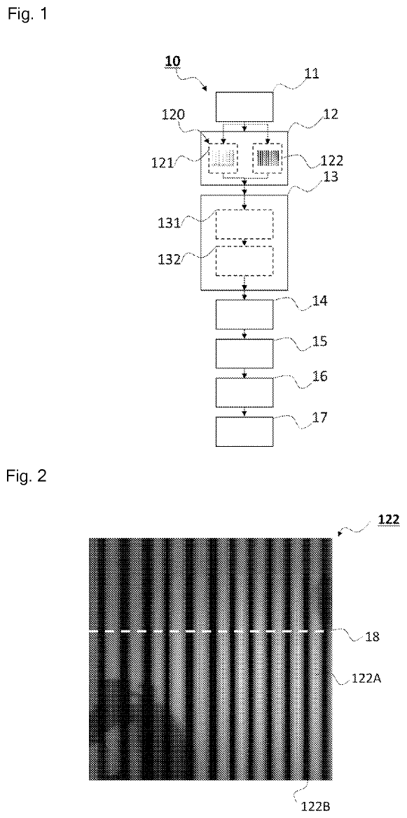

With reference to FIGS. 1 to 5, an embodiment of the decoding method 10 according to the first aspect of the invention is described below, the decoding method 10 comprising one or more iterations of the following steps:
a step of acquiring 11 the modulated light signal with an areal photodetector;
a step of converting 12 the light signal detected by the areal photodetector into a two-dimensional representation 122 representing a variation in light intensity of said light signal detected on the surface of said areal photodetector, the step of converting being carried out by an analog-digital converter;
a step of computing 13 a trend function using all or some of the two-dimensional representation 122, the step of computing being carried out by a computing unit;
a step of subtracting 14 the trend function from the two-dimensional representation 122 in order to obtain a processed signal from the light signal detected by the areal photodetector, the step of subtracting being carried out by the computing unit;
a step of scanning 15 the processed signal in order to detect all the occurrences of at least two frequencies of oscillation, the step of scanning being carried out by the computing unit;
a step of attributing 16 a logic value to each occurrence of the at least two frequencies of oscillation, each separate frequency of oscillation being associated with one separate logic value, the step of attributing being carried out by the computing unit;
a step of reconstructing 17 the digital data set from the attributed logic values, the step of reconstructing being carried out by the computing unit.

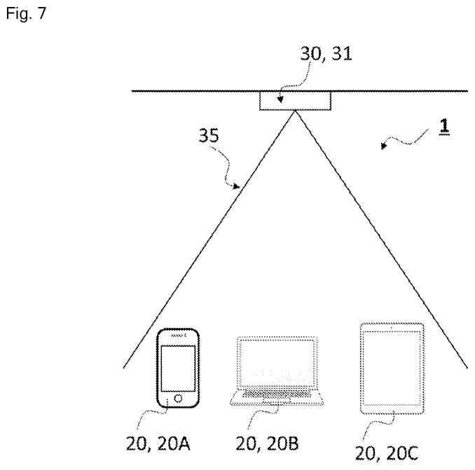

The step of acquiring 11 is carried out by any type of photodetector, but preferably by those of the areal photodetector type, for example a photodiode or a CMOS sensor or a CCD sensor. Embodiments of photodetectors used to implement this first step of acquiring 11 of the decoding method 10 according to the first aspect of the invention will be described in more detail below with reference to FIGS. 6 and 7. During the step of acquiring 11, a modulated light signal carrying a digital data set is detected and then transformed into an electrical signal which may then be subjected to computer and/or electronic processing in order to trace the bits contained in the transported digital data.

Therefore, the step of acquiring 11 and the subsequent step of converting 12 together make it possible to transform temporal variations in the light intensity of the modulated light signal, which carries the previously encoded digital data, into the two-dimensional and temporally variable representation 122, which will then be analyzed during the subsequent steps of the decoding method according to the first aspect of the invention.

According to an advantageous variant of the invention according to the first aspect thereof, the step of converting 12 comprises a two-dimensional representation step 120 during which light intensity values detected by the photodetector are stored 121 in a two-dimensional array 121 stored on a storage unit and/or light intensity values detected by the photodetector are represented in a two-dimensional image 122 displayed on a display device.

According to a first alternative embodiment not shown, the light intensity values of the modulated light signal are converted into computer data, organized in the two-dimensional array 121 according to their correspondence to the surface of the photodetector, and recorded successively in the storage unit, such that each time the photodetector is refreshed, the new detected light intensity values are recorded in the storage unit, one after the other, in a plurality of two-dimensional arrays 121. Each two-dimensional array 121 determined and recorded in this manner thus corresponds to a state of the photodetector at a given moment in time, and therefore to a portion of the digital data transported by the modulated light signal.

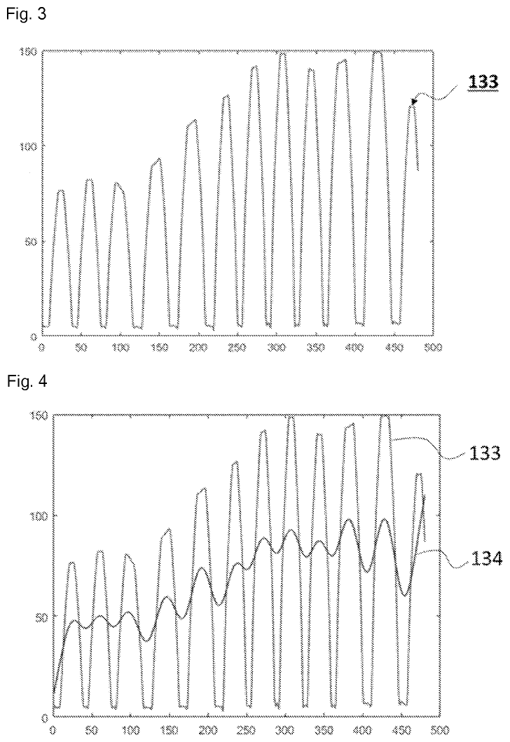

According to a second alternative embodiment, the light intensity values of the light signal modulated and detected by the photodetector are represented in a plurality of two-dimensional images 122, an example of which is illustrated in more detail in FIG. 2. A two-dimensional image 122 of this kind can advantageously be displayed on any type of display device. Each two-dimensional image 122 thus represents a state of the photodetector at a given moment in time, and therefore a portion of the digital data transported by the modulated light signal. In this form of two-dimensional representation 120, each column of the two-dimensional image 122 represents a state of the modulated light signal, and therefore corresponds to one bit of the transported digital data:
When the light source which generates this modulated light signal is off, which corresponds for example to a least significant bit of which the value is equal to 0, then the photodetector does not detect photons during the period during which the light source is off, and the two-dimensional image 122 comprises a dark line 1228 which spatially corresponds to this period during which the light source was off;
Conversely, when the light source which generates this modulated light signal is on, which corresponds for example to a most significant bit of which the value is equal to 1, then the photodetector detects photons during the period during which the light source is on, and the two-dimensional image 122 comprises a bright line 122A which spatially corresponds to this period during which the light source was on.

As such, the photodetector makes it possible to transform a temporal variation of the light intensity of the modulated light signal into a, preferably two-dimensional, spatial variation of the detected light intensity. This embodiment is most particularly achieved by implementing sequential detection of the different parts of the photodetector, in particular when the photodetector implements a moving shutter, as will be described in more detail with reference to FIG. 6.

In order to allow optimal decoding of the digital data transported by the modulated light signal detected by the photodetector, the step of computing the trend function 13 determines an overall behavior of the alternations between bright lines 122A, or high light intensity values, and dark lines 1228, or low light intensity values, present in the two-dimensional image 122, or in the two-dimensional array 121.

In order to optimally compute this trend function, it may be expedient to select 131 at least one subset of the two-dimensional representation 120 so as not to take into account certain artefacts that are not representative of the digital data carried by the modulated light signal and/or that are caused by occasional failures of the photodetector and/or that come from stray light detected by said photodetector.

By way of non-limiting examples of subsets that can be selected to determine the trend function, the decoding method according to the first aspect of the invention may comprise a step of selecting 131 a row or a column in the two-dimensional image 122 or in the two-dimensional array 121. More generally, the decoding method may comprise a step of selecting 131 a plurality of values of light intensities detected in a particular direction, preferably oriented parallel with respect to the variations in said detected light intensities, as indicated by the dashed line 18 in FIG. 2.

Alternatively or additionally, the step of selecting 131 the subset used to compute the trend function comprises calculating 132 a plurality of mean values of the light intensities represented in the two-dimensional image 122, or stored in the two-dimensional array 121. More specifically, the mean values are calculated for a line perpendicular to the variation in the detected light intensities, as indicated by the dashed line 18 in FIG. 2. Optionally, the step of selecting 131 comprises calculating a mean value for each column or row of the two-dimensional image 122, depending on the movement direction of the moving shutter of the photodetector.

FIG. 3 shows the mean variation in light intensity 133 calculated for each of the columns of the two-dimensional image 122 shown in FIG. 2.

The step of computing the trend function comprises at least one computing method chosen from a Baxter-King filter, a Christiano & Fitzgerald filter, a Hodrick-Pescott filter or a polynomial filter. The computing method or methods is or are applied to the subset selected during the preceding step of selecting 131.

FIG. 4 shows an example of a selected subset, corresponding here to the mean variation in light intensity 133 calculated for each of the columns of the two-dimensional image 122 and as illustrated in FIG. 3, as well as the trend function 134 computed on the basis of this subset.

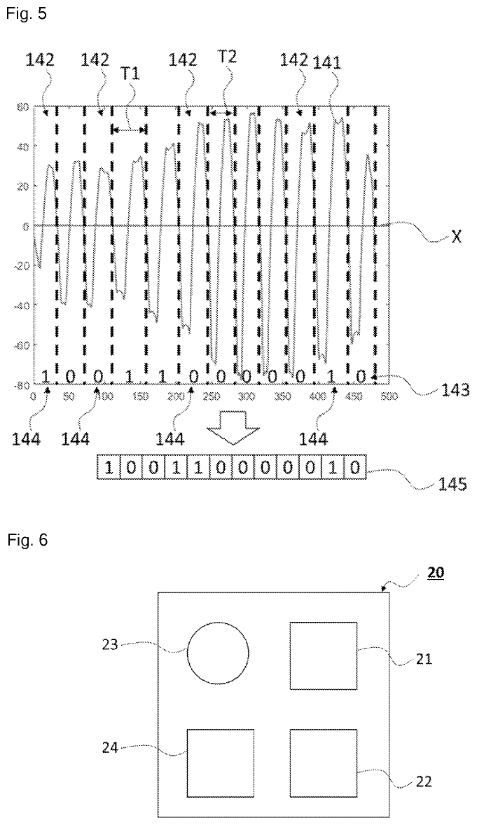

Subsequent to this computation, the decoding method according to first aspect of the invention comprises the step of subtracting 14 the trend function 134 from the chosen two-dimensional representation 122 in order to obtain the processed signal 141. FIG. 5 shows such a processed signal obtained by subtracting the trend function 134 from the mean variation in light intensity 133 calculated for each of the columns of the two-dimensional image 122.

Then, the decoding method according to the first aspect of the invention implements the step of attributing 16, during which the processed signal 141 is analyzed in order to identify the different occurrences of the first and second of oscillation in said processed signal 141. By way of non-limiting example, a step of determining the period or pseudo-period can be carried out on each portion 142 of the processed signal 141 taken between two falling edges of the processed signal 141 at the axis of origin X. These portions 142 are identified in FIG. 5 by vertical dashed lines.

A period or pseudo-period measurement on each of these portions 142 makes it possible to determine a value of a first period T1 and a value of a second period T2. For all the values of the first period T1 that are equal to a first reference value or included in a first confidence interval with respect to the first reference value, for example fixed at 10% of the first reference value, the corresponding portion 142 of the processed signal 141 is associated with a first logic value 144, for example equal to 1 here. Similarly, for all the values of the second period T2 that are equal to a second reference value or included in a second confidence interval with respect to the second reference value, for example fixed at 10% of the second reference value, the corresponding portion 142 of the processed signal 141 is associated with a second logic value 144, for example equal to 0 here.

It is thus possible to reconstruct a, for example binary, logic signal 143 from the processed signal 14. A logic signal 143 of this kind established during the step of reconstructing 17 of the decoding method according to the first aspect of the invention thus makes it possible to reconstruct the set of digital data 145 which were carried by the modulated light signal.

FIG. 6 illustrates an optoelectronic system 20 according to the second aspect of the invention and comprising means that are configured to implement the decoding method according to the first aspect of the invention and as described in the preceding paragraphs, for example.

More specifically, the means of such an optoelectronic system 20 are configured to:
acquire a modulated light signal emitted by a remote light source, not shown in FIG. 6;
convert the detected light signal into an electrical signal that is representative of the temporal variations of its light intensity;
carry out electronic and/or computer processing on the electrical signal representative of the temporal variations of light intensity in order to ultimately make it possible to reconstitute the set of digital data which were carried by the modulated light signal.

To this end, the optoelectronic system 20 according to the second aspect of the invention advantageously comprises:
a photodetector 23 that is configured to be able to detect a light communication signal. Preferably, the photodetector 23 is an areal photodetector, for example a CMOS sensor or a CCD sensor;
an analog-digital converter 21 that is configured to convert the modulated light signal detected by the photodetector 23 into a digital signal that is representative of the different levels of intensity of said modulated light signal;
a computing unit 22 that is configured to perform digital calculations and/or digital processing and/or logic operations on the digital signal. Preferably, the computing unit 22 is of the type having at least one microprocessor;
a storage unit 24 that is configured to store digital data; and/or
a display unit that is configured to display digital data, for example a digital display.

Advantageously, the photodetector 23 of the optoelectronic system 20 according to the second aspect of the invention is of the type comprising a moving shutter that makes it possible to “read” a quantity of photons detected by each photosensitive cell constituting the photodetector. Indeed, the presence of such a moving shutter makes it possible to sequentially read the various photosensitive cells of the photodetector, each row of photosensitive cells being “read” one after the other. Therefore, the detection of the light signal incident on the photodetector is done by moving the moving shutter, thus inducing the photons detected by a first row of the photodetector to correspond to a first state of illumination of the light source, and therefore to a first light intensity, whereas the photons detected by a second row of the photodetector and directly adjacent to the first row correspond to a second state of illumination of the light source, and therefore to a second light intensity. This particular acquisition method makes it possible to carry out a surface transcription, on the photodetector, of a temporal variation of the light intensity of the modulated light signal emitted by the light source.

It is this detection method which makes it possible to define a width of the bright 122A or dark 122b lines on the two-dimensional representation 122 described previously with reference to FIG. 2. Subsequently, a frequency of oscillation f of the modulated light signal is linked to a movement speed Tᵣ of the moving shutter by the following formula:

$$f = {( 2 {WT}_{r} )}^{- 1}$$

where W is the width in pixels of a row on the photodetector 23.

As mentioned previously, each logic value of the digital data carried by the modulated light signal is associated with a particular frequency of oscillation: the most significant bits equal to 1 are represented by a variation in intensity of the light signal according to a first frequency of oscillation, while the least significant bits equal to 0 are represented by a variation in intensity of the light signal according to a second frequency of oscillation. For proper functioning of the decoding method 10 according to the first aspect of the invention, and for better detection and processing at the optoelectronic system 20 according to the second aspect of the invention, the frequencies of oscillation chosen should be sufficiently distant from each other. By way of non-limiting example, it is possible to choose a first frequency of oscillation that is equal to half of the second frequency of oscillation.

For a better pairing of the light source and the associated optoelectronic system 20, the frequencies of oscillation of the modulated light signal should be defined in such a way that the first frequency of oscillation of the modulated light signal is detected by a number of rows of the photodetector 23 that is greater by at least 4 rows than the number of rows of said photodetector 23 that detect the second frequency of oscillation of said modulated light signal.

FIG. 7 illustrates a light communication system 1 comprising:
an emitting system 30 comprising at least one light source 31 that is configured to emit a light signal 35, an intensity and/or a frequency of which is modulated according to an encoded digital signal. The emitting system 30 is thus configured to emit a light communication signal, i.e. the modulated light signal 35, which carries previously encoded digital data; and
an optoelectronic system 20 according to the second aspect of the invention or according to any of the improvements thereto. As mentioned previously, the optoelectronic system 20 is configured to implement the decoding method 10 according to the first aspect of the invention in order to decode the digital data transported by the modulated light signal 35 that constitutes the light communication signal.

Particularly advantageously, within the context of the present invention, the optoelectronic system 20 is preferably a mobile phone 20A, digital tablet 20C or laptop 20B, in order to take advantage of one of the cameras integrated on these devices. Indeed, it is an aim of the invention to be able to be implemented by such an optoelectronic system 20 in order to facilitate the deployment of a geolocation application, for example.

In summary, the invention relates to a method for decoding 10 a modulated light signal 35 carrying a digital data set, the decoding method 10 comprising a step of searching 12, 13, 14, 15 for at least two frequencies of oscillation of a digital transcription of the light signal detected by a photodetector 23, each frequency of oscillation being representative of a logic value of the bits constituting the digital data carried by the light signal. Advantageously, a most significant bit is represented by a first frequency of oscillation and a least significant bit is represented by a second frequency of oscillation, the first frequency of oscillation being chosen so as to form, at the photodetector 23, a digital signal that is larger than that formed by the second frequency of oscillation by at least 4 elementary detection units of said photodetector 23.

The invention also relates to an optoelectronic system 20 that implements a decoding method 10 of this kind.

Of course, the invention is not limited to the examples which have just been described and numerous modifications can be made to these examples without departing from the scope of the invention. In particular, the different features, forms, variants and embodiments of the invention can be associated with each other in various combinations insofar as they are not incompatible or mutually exclusive. In particular, all the variants and embodiments described above can be combined with one another.

1. Method for decoding a modulated light signal carrying a digital data set, said method comprising at least one iteration of the following steps:
a step of acquiring the modulated light signal with an areal photodetector;
a step of converting the light signal detected by the areal photodetector into a two-dimensional representation representing a variation in light intensity of said light signal detected on the surface of said areal photodetector, the step of converting being carried out by an analog-digital converter;
a step of computing a trend function using all or some of the two-dimensional representation, the step of computing being carried out by a computing unit;
a step of subtracting the trend function from the two-dimensional representation in order to obtain a processed signal from the light signal detected by the areal photodetector, the step of subtracting being carried out by the computing unit;
a step of scanning the processed signal in order to detect all the occurrences of at least two frequencies of oscillation, the step of scanning being carried out by the computing unit;
a step of attributing a logic value to each occurrence of the at least two frequencies of oscillation, each separate frequency of oscillation being associated with one separate logic value, the step of attributing being carried out by the computing unit;
a step of reconstructing the digital data set from the attributed logic values, the step of reconstructing being carried out by the computing unit;
characterized in that the step of computing the trend function comprises a method chosen from a Baxter-King filter, a Christiano & Fitzgerald filter, a Hodrick-Pescott filter or a polynomial filter.

2. Decoding method according to claim 1, wherein the step of converting comprises a two-dimensional representation step during which light intensity values detected by the photodetector are stored in a two-dimensional array stored on a storage unit and/or light intensity values detected by the photodetector are represented in a two-dimensional image displayed on a display device.

3. Decoding method according to claim 2, wherein, before the step of computing the trend function, the decoding method comprises a step of selecting a subset of the two-dimensional representation, the step of computing the trend function being subsequently applied to the selected subset.

4. Decoding method according to claim 3, wherein the selected subset comprises at least part of a row or column of the two-dimensional representation.

5. Decoding method according to claim 3, wherein the step of selecting the subset comprises:
calculating a mean value for each row of the two-dimensional representation; or
calculating a mean value for each column of the two-dimensional representation.

6. Decoding method according to claim 1, wherein the step of scanning the processed signal consists in detecting a first frequency of oscillation of said processed signal and a second frequency of oscillation of said processed signal.

7. Decoding method according to claim 6, wherein the first frequency of oscillation is at least two times higher than the second frequency of oscillation.

8. Optoelectronic system for detecting a light communication signal, the optoelectronic system comprising means that are configured to implement the decoding method according to claim 1.

9. Optoelectronic system according to claim 8,
wherein the optoelectronic system comprises:
a photodetector that is configured to be able to detect a light communication signal;
an analog-digital converter that is configured to convert the light communication signal detected by the photodetector into a digital signal that is representative of the different levels of intensity of said light communication signal;
a computing unit that is configured to perform digital calculations and/or digital processing and/or logic operations on the digital signal;
a storage unit that is configured to store digital data; and/or
a display unit that is configured to display digital data.

10. Light communication system, comprising:
an emitting system that comprises at least one light source that is configured to emit a light signal of which an intensity and/or a frequency is modulated according to an encoded digital signal; and
an optoelectronic system according to claim 8.
